(19) United States
(12) Patent Application Publication
(10) Pub. No.: US 2014/0150651 A1
(43) Pub. Date: Jun. 5, 2014

(54) SYSTEM AND PROCEDURE FOR EXTRACTING WATER FROM THE ENVIRONMENT

(71) Applicant: Francisco Javier Velasco Valcke, Bogota (CO)

(72) Inventor: Francisco Javier Velasco Valcke, Bogota (CO)

(73) Assignee: PANACEA QUANTUM LEAP TECHNOLOGY LLC, Dallas, TX (US)

(21) Appl. No.: 14/126,130

(22) PCT Filed: Jun. 15, 2012
(86) PCT No.: PCT/IB2012/053044

§ 371 Date: Jan. 27, 2014

(30) Foreign Application Priority Data
Jun. 15, 2011 (CO) 11-074822

(51) Int. Cl. B01D 53/26

(52) U.S. Cl. CPC B01D 53/261
USPC 95/126; 96/146

(57) ABSTRACT

This invention provides a simple and energy-efficient process for obtaining water from air through better use of the solid desiccants using a high heating cycle in a confined space, applying minimal air flow and avoiding the use of a chilled condenser plate. The process of obtaining water in this invention consists of the production of water using, in one embodiment, a rotating drum covered with a desiccating material, a device that generates heat in a confined space, and a collection chamber. The process begins with charging the adsorbent material, which captures water vapor from the environment. Then, a discharging stage occurs through which an area of the desiccated material is exposed to controlled heating in a confined space, allowing the trapped water vapor to be released from the desiccant. A very light air flow may also be applied to increase the draw of the water vapor toward the area of condensation. A collection chamber is installed under the drum, allowing condensation of the water vapor released from the desiccating material. The recovered water accumulates and is stored in a storage tank. This invention does not need a chilled condenser plate to obtain the water vapor released by the desiccating material. As the process takes place, the drum rotates in such a fashion that the area with the charged desiccating material can be heated, allowing the area with the discharged desiccant to be charged again.

### 1. AREA OF THE INVENTION

This invention is related to dehumidifiers and, in particular, to systems that obtain water from the air through adsorbent materials.

### 2. DESCRIPTION OF THE STATE-OF-THE-ART

The objective of dehumidification processes is to absorb moisture from the environment using materials designed to achieve an equilibrium between the moisture of the surrounding environment and the level of moisture in the materials. When it is necessary to also combat elevated latent moisture loads, desiccants are used to lower the moisture content of the air in thermal processes. A desiccant is a chemical substance that has a great affinity for moisture—in other words, it is capable of extracting water vapor from the air in relatively large quantities in relation to its weight and volume. The physical process that allows the retention or release of moisture is the difference in vapor pressure between the surface of the desiccant and the ambient air. Their water retention properties are due to surface adsorption and capillary condensation. Desiccants can be classified as absorbents that undergo chemical changes when they retain or release moisture or absorbents that retain or release moisture without being accompanied by chemical changes; in other words, the only change is the addition of the mass of the water vapor to the desiccant. Adsorbents have nanopores where the bonding forces between the atoms are not saturated. These active centers allow molecules of a different nature from their own, derived from a gas in contact with their surface, to be attached. Adsorption is an exothermal process and is produced spontaneously if the adsorbent is not saturated.

Desiccants can be solids or liquids. Solid desiccants attract moisture due to the electrical field on the surface of the desiccant. This field is not uniform in its strength or charge, so it attracts water molecules with an opposite net charge to specific sites on the surface of the desiccant. Various types of solid desiccants are frequently used in refrigeration systems, including silica gel, lithium chloride, zeolites, synthetic zeolites, alumina, activated charcoal and synthetic polymers.

The most widely applied substance, silica gel, has a structure of amorphous micropores with an opening size distribution between 0.3 nm and 6 nm. These interconnected pores give rise to a large surface that attracts and holds water through adsorption and capillary condensation, allowing the silica gel to incorporate water up to 40% of its weight.

Dehumidification of the air with desiccants occurs when the vapor pressure of the surface of the desiccant is less than that of the ambient air. When water vapor is adsorbed the vapor pressure in the desiccant increases until equilibrium is achieved. This happens when the vapor pressure in the desiccant and in the air are equal. To be able to re-use the desiccant, it is necessary to regenerate it—in other words, it is necessary to remove the moisture from it. Regeneration or the release of adsorbed water vapor from the desiccant is achieved by heating it to increase the vapor pressure, followed by contact with an air current that has a lower water vapor pressure. For some desiccants, the release of adsorbed water vapor can take place at a temperature of approximately 45° C.

The state-of-the-art is based on systems that reduce moisture in the environment through the use of desiccating materials. Various documents discuss the principle of charging and discharging the desiccating material with different air flows. Specifically, the prior art is based on adsorption of moisture from the environment by causing the air flow pass through a rotor with desiccant, which is then heated by a heating system in another section of the rotor, thus releasing the adsorbed water vapor in order to reinitiate the cycle of moisture adsorption. In all cases, the devices use a refrigerated condensation plate along with a rotor that has desiccating material to trap water vapor in the air, discharge the water vapor, and then condense it. This means that the state of art uses refrigeration methods to condense the water vapor recovered from a desiccating material. However, these methods of refrigeration for trapping moisture are energy intensive.

By means of illustration, U.S. 2010/192605(A1) describes a system for moisture control using a low level of residual heat to assist in releasing adsorbed water vapor from a desiccating material. The system consists of a duct that takes air from the environment and directs it to a rotor with a desiccating material. The rotor adsorbs most of the moisture from the air in the duct. The system releases the adsorbed water vapor through a duct for releasing the adsorbed water vapor which directs a heated air flow against the walls of the rotor. Additionally, the duct for releasing the water vapor is connected to a compressor to increase the temperature of the air and assist in regenerating the desiccant. The dehumidification system necessarily also includes a condenser plate to trap moisture from the air and condense it.

U.S. Pat. No. 6,935,131 discloses a dehumidifying unit that consists of an air current from a process with a heating coil connected to a heat line from the compressor of the refrigeration unit. This coil heats the regenerated air supplied to the section that releases water vapor adsorbed from a dessiccant wheel to increase the system's capacity to extract moisture from the process air current. This patent teaches a circuit to preheat the air supplied to the dessiccant wheel in the system to extract moisture. The water vapor releasing circuit also includes a condenser plate connected to a refrigeration circuit comprising a compressor and a heat exchanger.

U.S. 20040711301 describes a system for adsorbing moisture from the environment, for example for ice rinks or commercial facilities. The device consists of an enclosed area with a series of cooling plates and a moisture control system assisted by desiccants. The moisture control system is based on passing a current of moist air (charging) through a section of the desiccant rotor, and a conduit for releasing adsorbed water vapor that basically consists of passing heated air over electrical resistances (discharging). The conduits for charging and discharging the system are also connected to a chilled condenser plate.

Lastly, U.S. Pat. No. 4,365,979 makes known an apparatus for producing water by adsorbing moisture from the environment with a desiccating material placed in a cylinder that rotates around a shaft. A ventilator creates an air current that strikes the desiccant, which adsorbs moisture from the water. The device has a duct behind the desiccant that receives the air which is forced through by the ventilator and passes over some resistances that heat the air, then causing it to strike a condenser plate. The condenser plate is connected to a tank, which is where the condensed water is collected. The residual hot air current is made to strike the desiccating material to release the water vapor contained in the desiccant, thus restarting the cycle of charging and discharging the desiccant.

These prior art disclosures describe a cyclical process of charging and discharging the desiccating material so that it captures and releases moisture from the air. The prior art documents disclose systems that heat the desiccating material and apply a significant air flow to pull the water vapor released by the desiccating material. All the devices subsequently cause the air flow to strike a chilled plate, which reduces the efficiency of capturing water from the air.

### 3. DESCRIPTION OF THE FIGURES

The invention will be described through the following drawings, which include reference numbers for identifying the component parts:

FIG. 1 is a schematic diagram of an embodiment of the present invention.

FIG. 2 is a detailed view of one section of the example of embodiment in FIG. 1.

### 4. BRIEF DESCRIPTION OF THE INVENTION

This invention is intended to provide a simple an energy-efficient process for obtaining water from air through better use of the solid desiccants using a high heating cycle in a confined space, applying minimal air flow and avoiding the use of a chilled condenser plate.

The process of obtaining water in this invention consists of the production of water using, in one embodiment, a rotating drum covered with a desiccating material, a device that generates heat in a confined space, and a collection chamber. The process begins with charging the adsorbent material, which captures water vapor from the environment. Then, a discharging stage occurs through which an area of the desiccated material is exposed to controlled heating in a confined space, allowing the trapped water vapor to be released from the desiccant. A very light air flow may also be applied to increase the draw of the water vapor toward the area of condensation. A collection chamber is installed under the drum, allowing condensation of the water vapor released from the desiccating material. The recovered water accumulates and is stored in a storage tank. This invention does not need a chilled condenser plate to obtain the water vapor released by the desiccating material. As the process takes place, the drum rotates in such a fashion that the area with the charged desiccating material can be heated, allowing the area with the discharged desiccant to be charged again.

### 5. DETAILED DESCRIPTION OF THE INVENTION

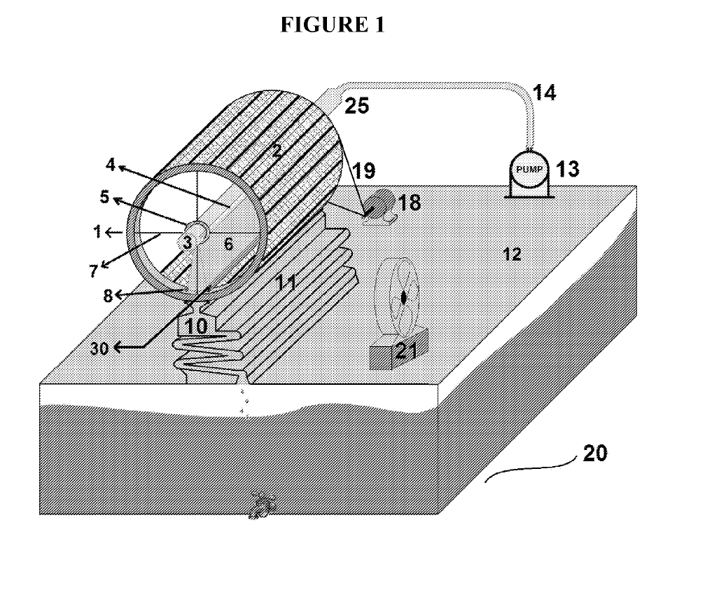

FIG. 1 shows a schematic diagram of a device (20) according to one embodiment of the invention. The device (20) is made up of a series of elements that allow extraction of the water in three stages, namely:

(i) a first stage of water adsorption involving a rotating drum (1) that turns on a fixed shaft (3), where the drum (1) is covered by a double mesh containing a desiccating material (2). The double mesh consists of two perforated sheets with holes of a size that are smaller than the particles of the solid desiccant, so that the mesh allows air to flow through the desiccating material (2) without allowing the material to escape. In this first stage, water vapor in the air is absorbed by the desiccating material (2).

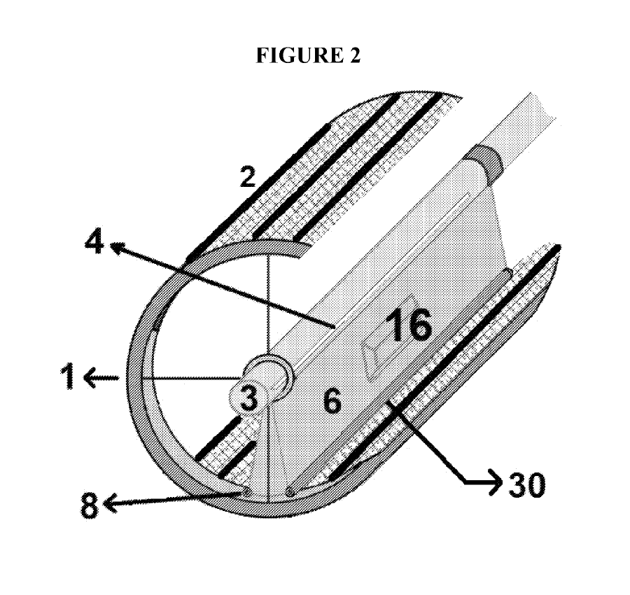

(ii) a second stage of extraction during which heat is applied to an area of the desiccating material within a confined space. To achieve this, and in reference to FIGS. 1 and 2, the fixed shaft (3) is hollowed, allowing the air to pass from the end connected to an intake pipe (25) to a transfer chamber (6) through a groove (4) on the underside of the shaft (3).

The pump (13) creates low pressure to generate a very light air flow toward and through the transfer chamber (6). The transfer chamber (6) covers a specific area of the drum and generates a confined space to avoid air leaks. The transfer chamber (6) has within it a heat generator (16), for example, a magnetron, that allows the air in the confined volume as well as the desiccant to be heated, thus causing expansion and release of the water vapor in the desiccant. With this heating, the desiccating material (2) delivers the adsorbed water vapor, which is carried by the air flow to a collection chamber (10), where the water vapor is condensed.

(iii) a third stage of recovery where the water vapor removed from the desiccating material is condensed and stored. To achieve this, as illustrated in FIG. 1, the water vapor released by and carried through the desiccated material (2) comes to a condensation chamber (10), which is connected on its underside to a dissipator coil (11), which transports the condensed water to a storage tank (12).

In the first stage of adsorption of moist air, the drum (1) is a hollow cylindrical structure wrapped in a double mesh that contains the desiccating material (2). The double mesh is closed off on the ends to retain the desiccating material (2). It can also be sewn into stitches to keep the desiccant from moving, which could generate undesired accumulations or spaces. The drum provides means to ensure the double mesh is operatively adjusted to the collection chamber (10) creating a substantially sealed space between the desiccating material (2) and the chamber (10). For example, the drum can have sealing rails (30) which help form a seal between the drum section being heated and the edges of the transfer chamber (6).

The desiccating material (2) can be any type of solid desiccant, like virgin or white silica gel, lithium chloride, zeolites, synthetic zeolites, alumina, activated charcoal, or synthetic polymers that generally have a granulometry of 3 mm to 8 mm. In the example of the embodiment of FIG. 1, it uses silica gel as a desiccating material (2) because this is a solid desiccant containing numerous pores and capillaries with a high capacity for adsorbing moisture and the ability to regenerate itself. The double mesh consists of two perforated sheets with holes that can be of different diameters as long as they are smaller than the diameter of the particles of the solid desiccant (2). The double mesh can be constructed of a polymeric material like Teflon. A metal material can also be used for the double mesh, but in this case, a heating element, like a magnetron, cannot be used.

In other embodiments not illustrated here, this invention can incorporate different types of configurations that do not include a cylindrical drum to house the desiccating material. For example, one of them can be a closed container containing one or several tray-like surfaces with the desiccating material inside. The operating principle would be based on a charging period where air is passed through the desiccating material and an outflow composed of tubes that condense and transport the water to a holding tank. The air flow can be heated by a heating element to expand and release the water vapor from the desiccant to a holding tank. It must be understood that this invention is not limited to the embodiments described here, but additional configurations can exist that fulfill the same purpose of extracting water from the ambient air based on desiccant materials. In other embodiment not illustrated here, the drum can be replaced by conveyor belts, discs or similar mechanisms that contain the desiccant material and can be exposed to cycles of charging and discharging.

In the second stage of extraction, the air flow that passes through the device to the desiccant material (2) must be a light air current so that the flow is capable of carrying the released water vapor to the collection chamber (10). Accordingly, it does not require a flow volume comparable to the devices made known in the state-of-the-art. This invention does not require the air flow entering the transfer chamber (6) to be preheated; on the contrary, the air can be at ambient temperature. However, there can be embodiments where the air is heated so as to take advantage of the air's thermal capacity for regenerating the desiccant (2).

For example, solar panels or devices with electrical resistance can be used to preheat the incoming air flow. One can also take advantage of the heat generated by manufacturing or cogeneration processes. In other embodiments of this invention, like the example of embodiment in FIG. 1, the air flow generated by the pump is recirculated through the pipes connecting the pump (13) to the shaft (3) of the drum (1), then to the coil chamber (10), finally passing on to the storage tank (12) and again to the air pump (13). The air that recirculates can have a temperature higher than that of the environment, thereby again taking advantage of this thermal capacity for regenerating the desiccant material (2) and reducing the energy consumption of the system. In other embodiments, the air flow from the air pump (13) can be programmed in on-off cycles to generate an optimal low air speed.

The second stage of extraction, and referring again to FIGS. 1 and 2, begins with carrying the air volume from the air pump (13) to the shaft (3). As mentioned previously, the devices to generate this light air flow toward the desiccant material (2) can vary. In particular, a pump is not essential, for example, because one can take advantage of a process of heat expansion of the air in the pipes that feed the shaft (3) to generate an air flow.

The embodiments that use an air pump have a pipe (14) with a diameter allowing a constant air flow, which does not generate sudden changes of pressure and speed. The pipe (14) is operationally connected to the hollowed out shaft (3) at the end (25) to transmit the air to the transfer chamber (6) and lastly over the desiccating material (2).

As can be seen in FIG. 2, the shaft (3) is fixed in relation to the rotating drum (1) so that the surface of the desiccating material (2) keeps turning and the transfer chamber (6) covers a section of the desiccating material (2) of the inside surface of the drum (1). The transfer chamber (6) is essentially hermetically sealed to the groove (4) to prevent the air from escaping the device (20). The underside of the transfer chamber (6) is joined to the cylindrical surface of the drum (1) where the desiccant material (2) is found, substantially preventing losses of air flow and temperature. For example, some sealing rails (30) can be installed in the union between the chamber (6) and the walls of the drum (1) to prevent air leaks. The chamber (6) is in contact to the drum (1) by means of rotatable members (8). Rotatable members (8) are coupled to the chamber (6) and facilitate rotation of the drum (1) around chamber (6).

The transfer chamber (6) is coupled to a heat-generating device (16) designed to expand the water vapor in the desiccant so that it releases it, regenerating the desiccant. In the example of embodiment, the heat-generating device (16) is a magnetron. Specifically, the magnetron heats and expands the air in the desiccant, causing an increase in pressure in the surface of the desiccant, producing the release of the water, without the need for an air current. As this light air flow passes through the desiccating material (2) and is heated by the heat generator (16), the retained water vapor is condensed over the coil chamber (10). This air flow facilitates the transfer of the water vapor to the coil chamber (10).

As the air passes through the surface of the drum (1) and the desiccant is regenerated (2), the drum turns on the shaft (3) due to the weight differential between the desiccant (2) charged with water vapor and the regenerated desiccant (2). The drum (1) is coupled to the shaft (3) through some spokes (7) that hold the drum (1) centered on the shaft (3). The spokes (7) are coupled to the shaft (3) by bearings (5) that allow the drum (1) to turn freely.

Additionally, as in the embodiment illustrated in FIG. 1, the drum (1) can also be connected to a motor (18) through a pulley (19) to force the movement of the drum (1) at a constant speed.

The third stage of recovering the water consists of cooling and transporting the water obtained from the air to a storage tank (12). The water vapor recovered from heating the desiccant material (2) is carried by the air flow to a coil chamber (10) that condenses the vapor and then the water falls on a dissipator coil (11) which cools the water and takes it to a storage tank (12). Although not necessary, the dissipator coil (11) can additionally be cooled by a ventilator (21) which directly faces it to generate an air flow against the walls of the coil (11), thus helping to chill the condensed water.

### EXAMPLE

A preferred embodiment of this invention is described below. Referring once again to FIGS. 1 and 2, the device (20) for this invention was operating in an environment where the percent relative humidity was close to 60% and the dewpoint was close to 19° C. The device (20) of the preferred embodiment consists of a storage tank (12), an air pump (13), a pipe (14) that connects the pump (13) to the shaft (3), a rotating drum (1), a desiccant (2) covering the drum (1), a dissipator coil (11), a transfer chamber (6), a heating device (16) and their respective elements of contact, turning and communication. Fan (21) is not present in this preferred embodiment.

The pump (13) is a 12 watt pump running on 12 VDC, taken from a hand vacuum cleaner in which the motor is connected to a 7.5 cm diameter propeller with 6 blades, where the motor produces a rotation of 750 revolutions per minute.

The diameter of the pipe (14) coming from the pump (13) to the shaft (3) is 2.54 cm and is 1.70 m long to the end (25) of the shaft (3). The low energy consumption pump (13) generates a constant air flow through the 2.54 cm pipe to the shaft (3).

The rotating drum (1) has a length of 24 cm and a diameter of 24 cm. The perimeter of the rotating drum (1) is 75.4 cm. The total area of the desiccant (2) is equal to the perimeter multiplied by the length of the rotating drum (1), or 1810 cm².

In building the perforated mesh, 24 cm wide by 75 cm long sheets of Teflon mesh were used. The holes in both meshes have a maximum diameter of 3 mm (because the desiccant has a granulometry of over 3 mm) White or virgin silica gel was used with a granulometry of 3 mm to 5 mm. A larger amount of silica gel was placed on top of one of the meshes and distributed over the mesh area, so as not to leave any spaces. Then the second mesh was placed on top of the silica gel so that it was sandwiched in between the meshes. The ends of the meshes were joined, so as to prevent the solid desiccant from escaping. Then the meshes were wrapped around the turning drum (1), making a cylindrical structure covered with desiccant material (2).

The air flow coming from the air pump (13) enters the shaft (3) of the rotating drum (1), and is then transferred through the groove (4) to the transfer chamber (6). The transfer chamber (6) is connected to the groove (4) on one end while the other end is making contact with the walls of the rotating drum (1) to prevent air from leaking from the union between the chamber (6) and the walls of the drum (1), thanks to some sealing rails (30) distributed around the drum. In this embodiment, the end of the transfer chamber (6) covers ¼ of the total area of the rotating drum (1). In this example, the area that has the function of drying the desiccant is one-fourth of the total area of the desiccant—in other words, (1810 cm²)/4=452 cm².

To achieve the drying of the desiccating material (2), a heating device (16) was attached to the side of the transfer chamber (6), which in this example is a magnetron. The magnetron operates on 110 V AC at a frequency of 60 Hz and a power of 750 watts. The magnetron in this example can heat a charge of 1000 g of water with ease. Various measurements were carried out to determine the amount of water adsorbed by the desiccating material (2). One-fourth of the desiccant (2) discharged from the rotating drum (1) was weighed, and a weight of 200 g was obtained. The same measurement was done, but when the desiccating material (2) was charged, a weight of 250 g was obtained. In other words, based on the experiment, 200 g of desiccating material can retain 50 g of water. A complete rotation therefore produces 200 g of water.

To rotate the drum (1), a motor (18) was connected to a pulley (19) to generate 1 rotation every 40 minutes—in other words, a speed of 75.4 cm/40 mins=1.88 cm/min. Thus, the device produces 200 g of water every 40 minutes, or 9.3 liters/hour, or 7.2 liters/day.

In another preferred embodiment, the same motor (18) can be used not continuously but in an interrupted manner—in other words, the motor control is the on-off type. In this embodiment, the motor stays on for 20 seconds and off for 20 seconds. In this case, the efficiency of water adsorption is similar to that achieved when the motor runs continuously. In this model, the desiccating material was weighed when it was charged and discharged, and very similar results were obtained.

The ambient temperature in the transfer chamber (6) generated by the magnetron (16) can range from 70° C. to 110° C., but optimally it should be 90° C.

The entrained air flow and the condensed water pass through the dissipator coil (11) whose profile is 10 cm wide and 1 cm deep in the curvature of said coil.

It must be understood that this invention is not limited to the embodiments described and illustrated above. A person skilled in the art will understand that numerous variations and modifications can be carried out that do not depart from the spirit of the invention, which is only defined by the following claims.

1. Process for extracting water from the environment comprising the following steps:
a—adsorbing water vapor from the environment using a desiccating material;
b—extracting the water vapor adsorbed into the desiccating material by applying heating methods in a substantially confined volume;
c—condensing the water vapor extracted in (b) through subjecting the water vapor to the ambient temperature;
d—recovering the water vapor condensed in (c).

2. Process according to claim 1, in which the condensation step is performed by subjecting the water vapor extracted in stage (b) to an air flow and channeling it to a coil.

3. Process according to claim 1, in which the desiccant is laid out on a perforated cylindrical drum.

4. Process according to claim 1, in which the heating means are chosen from the group that consists of a magnetron, a resistance, solar panels and a preheated air flow.

5. A system for extracting water from the environment which includes:
a—a source of air flow;
b—a cylindrical drum;
c—a perforated sheet that contains a desiccating material and that covers the cylindrical drum, in which the desiccating material adsorbs water from the environment;
d—a hollowed out shaft connected coaxially to the cylindrical drum, which is connected at one end to the air flow source, and which has a groove leading into a transfer chamber in which the transfer chamber covers a predefined area of the desiccating material;
e—a heat generator coupled to the transfer chamber;
f—a condensation chamber against which the released water vapor is drawn to by the air flow, thus cooling it and recovering the adsorbed water; and
g—a storage tank that receives the recovered water vapor.

6. The extraction system according to claim 5, in which the diameter of the openings in the perforated sheet is 3 mm to 5 mm.

7. The extraction system according to claim 5, in which the material for the perforated sheet is Teflon.

8. The extraction system according to claim 5, in which the desiccating material is a synthetic polymer.

9. The extraction system according to claim 8, in which the synthetic polymer is silica gel.

10. The extraction system according to claim 5, in which the transfer chamber creates a confined space on top of the desiccating material.

11. The extraction system according to claim 5, in which the system can include a fan (21) for cooling the dissipator coil (11).
